(19) United States
(12) Patent Application Publication
(10) Pub. No.: US 2021/0354735 A1
(43) Pub. Date: Nov. 18, 2021

(54) TELESCOPIC MULTIFUNCTIONAL WORKING VEHICLE CAPABLE OF OPERATING IN BOTH DIRECTIONS AND EVACUATING TRANSVERSELY AND APPLICATION METHOD THEREOF

(71) Applicants: SHANGHAI CIVIL ENGINEERING CO., LTD OF CREC, Shanghai (CN); HUAHAI ENGINEERING CO.,LTD OF CREC SHANGHAI, Shanghai (CN)

(72) Inventors: Xisheng LIU, Shanghai (CN); Xin HUANG, Shanghai (CN); Kanghai ZHENG, Shanghai (CN); Jiandong HAN, Shanghai (CN); Junxi SUN, Shanghai (CN); Wenjun ZHAO, Shanghai (CN); Fuping CHEN, Shanghai (CN); Mingfa XU, Shanghai (CN)

(21) Appl. No.: 16/333,986

(22) PCT Filed: Oct. 24, 2018
(86) PCT No.: PCT/CN2018/111601

§ 371 Date: Mar. 15, 2019

(30) Foreign Application Priority Data
Nov. 24, 2017 (CN) 201711188087.X

(51) Int. Cl. B61K 5/02; B61D 15/00; E01B 29/16

(52) U.S. Cl. CPC B61K 5/02; E01B 29/16; B61D 15/00

(57) ABSTRACT

The present invention relates to the technical field of engineering technology equipment and methods, in particular to a telescopic multifunctional working vehicle capable of operating in both directions and evacuating transversely, and an application method thereof. The telescopic multifunctional working vehicle comprises a fixing and lifting mechanism and a transverse moving and lifting mechanism. The working vehicle is composed of a front vehicle body and a rear vehicle body, wherein the front vehicle body is connected with the rear vehicle body through a telescopic mechanism used for realizing the contraction and the expansion between the front vehicle body and the rear vehicle body. The working vehicle is further provided with a hanging system used for hanging and moving working devices. A rail clamping device is arranged at the bottom of the working vehicle.

### TECHNICAL FIELD

The present invention relates to the technical field of engineering technology equipment and methods, in particular to a telescopic multifunctional working vehicle capable of operating in both directions and evacuating transversely, and an application method thereof.

### BACKGROUND ART

At present, in the construction of a seamless track of urban rail engineering in China, construction process equipment for normalizing operation, weld grinding, steel rail straightening and the like is mainly realized by manual handling and operation. Due to the cumbersome equipment and the lack of targeted conveying tools, personnel and equipment are often damaged. The following defects are resulted: an operating flat truck is mainly driven by man power; operating equipment is carried by man power; a steel rail is lifted by using a track lifting jack or other tools; construction equipment cannot make way for a line because it needs to be evacuated by man power; the transfer of working surfaces depends on the transportation with a large track transportation vehicle. In summary, the existing construction tools have the defects of low working efficiency, large labor intensity, frequent assembly and disassembly of components, and safety risks such as electric shock and object striking. Meanwhile, during the operation, the existing construction tools easily interfere with other cross-work operations and thus cannot make way for a passage or transfer a working surface, thereby affecting the construction efficiency. Therefore, the existing equipment cannot meet the current rail transit development needs.

In the rapid development of modern track construction technology, in order to meet the higher requirements on track construction efficiency, it is an inevitable trend for seamless line construction equipment to realize mechanization of working surface construction, integration of complete machine, convenience in construction, rapid transfer, and mechanical lifting of steel rails. During the seamless track operation, weld grinding, weld normalizing, steel rail strengthening, steel rail flaw detection, etc. can be realized on comprehensive equipment. Therefore, it is an inevitable trend to develop a telescopic working vehicle capable of operating in both directions and evacuating transversely, which can complete a plurality of procedures once without occupying a large number of resources, realizes zero time consumption during procedure connection, and is energy-saving, environment-friendly, safe and reliable.

### SUMMARY OF THE INVENTION

An objective of the present invention is to overcome the defects of the prior art and to provide a telescopic multifunctional working vehicle capable of operating in both directions and evacuating transversely. The telescopic multifunctional working vehicle can carry a working implement to quickly arrive at or evacuate from a construction working surface, and quickly lift a steel rail released from a fastener to a desired height, thereby meeting the working requirements of normalizing treatment, weld grinding, steel rail strengthening or weld flaw detection. Meanwhile, the telescopic multifunctional working vehicle can walk transversely away from a track and make way for an working vehicle on a main line when working equipment cannot evacuate in a long and large area, so as to solve the problems that the existing working implement causes large labor intensity and low working efficiency because the existing working implement is carried by man power and the steel rail is lifted by man power, such that they cannot make way for other working equipment on a main line track to pass, and the transfer in a long distance depends on loading and conveying of large special transportation equipment.

To fulfill said objective, there is designed an telescopic multifunctional working vehicle capable of operating in both directions and evacuating transversely, comprising a fixing and lifting mechanism and a transverse moving and lifting mechanism, wherein the fixing and lifting mechanism is used for supporting and lifting the working vehicle; the transverse moving and lifting mechanism is used for transversely moving and lifting the working vehicle; the working vehicle is composed of a front vehicle body and a rear vehicle body, wherein the front vehicle body is connected with the rear vehicle body through a telescopic mechanism used for realizing the contraction and the expansion between the front vehicle body and the rear vehicle body; the working vehicle is further provided with a hanging system used for hanging and moving working devices; a rail clamping device is arranged at the bottom of the working vehicle.

The telescopic mechanism comprises at least one longitudinal beam; each longitudinal beam is composed of longitudinal beam guide sleeves at two ends and a longitudinal beam guide column between the longitudinal beam guide sleeves; the longitudinal beam guide sleeves at two ends are fixedly connected with the front vehicle body and the rear vehicle body respectively; the longitudinal beam guide sleeves are capable of moving along the longitudinal beam guide column to realize the contraction and the expansion between the front vehicle body and the rear vehicle body.

The transverse moving and lifting mechanism is composed of a transverse moving mechanism and a lifting mechanism; the transverse moving mechanism comprises a transverse moving guide sleeve and a transverse moving guide column disposed in the transverse moving guide sleeve; the transverse moving guide sleeve is fixed at the lower end of the working vehicle; the transverse moving guide column is capable of moving along the transverse moving guide sleeves to realize the expansion and contraction of the transverse moving mechanism; the lifting mechanism is arranged at the outer end of the transverse moving guide column.

The hanging system is arranged on the longitudinal beam.

The working devices include a normalizing device, a strengthening device and a polishing device.

A thrust wheel is arranged below a proximal end of the front vehicle body and a proximal end of the rear vehicle body respectively; each thrust wheel is capable of contracting to a position close to the corresponding vehicle body.

An application method for the telescopic multifunctional working vehicle capable of operating in both directions and evacuating transversely comprises a working method which is specifically as follows:

a1. operating the working vehicle to run to a working site; relieving a longitudinal separation constraint between the front vehicle body and the rear vehicle body; putting the thrust wheel in the middle of each vehicle body down; operating a telescopic mechanism to enable the front vehicle body and the rear vehicle body of the working vehicle to expand and to extend to a designated working position respectively, and then locking vehicle braking and the telescopic mechanism;

a2. operating the rail clamping device mounted below the working vehicle to clamp a steel rail;

a3. operating the transverse moving and lifting mechanism of the working vehicle to lift the working vehicle and the steel rail, such that the steel rail leaves from a track bed surface by a set height, and then supporting a space below the lifted steel rail;

a4. operating the hanging system of the working vehicle to lower the working devices to the lower steel rail for working; then lifting the working devices;

a5. removing the support from the lower part of the steel rail, and operating the transverse moving and lifting mechanism of the working vehicle to lower the working vehicle and the steel rail, such that the steel rail falls into a rail bearing slot of the track bed and the working vehicle fails onto the steel rail; relieving the clamping of the rail clamping device to the steel rail; and

a6. relieving the vehicle braking, and operating the telescopic mechanism to contract the front vehicle body and the rear vehicle body of the working vehicle; then operating the working vehicle to run to the next working surface or directly operating the working vehicle to run to the next working surface; and repeating the steps a1-a5.

The application method further comprises a transverse moving make-way method, wherein the transverse moving make-way method is specifically as follows:

b1. longitudinally contracting the front vehicle body and the rear vehicle body of the working vehicle to a shortest state, and locking the telescopic mechanism;

b2. supporting the working vehicle by the fixing and lifting mechanism, and operating the transverse moving and lifting mechanism of the working vehicle to extend towards the make-way side of the vehicle, and meanwhile the non-make-way side of the vehicle approaches to the working vehicle.

b3. operating the transverse moving and lifting mechanism of the working vehicle to lift the entire working vehicle, such that running wheels of the working vehicle are away from the steel rail surface; then operating the transverse moving and lifting mechanism to move the working vehicle towards the make-way side;

b4. operating the fixing and lifting mechanism to support the working vehicle after transverse moving is completed, and then operating the transverse moving and lifting mechanism to return to a set height position that is off the ground; and

b5. repeating the steps b2-b4 to complete long-distance transverse moving make-way of the working vehicle.

Compared with the prior art, the present invention has a simple and feasible combined structure and has the following advantages:

1. the working vehicle adopts a telescopic structure, and the vehicle bodies can be longitudinally telescopic, which is convenient for operation, driving and transfer;

2. the working vehicle is driven by electric power and shares the electric power with the track construction, thereby not only saving a space occupied by the vehicle bodies, but also saving energy sources; the complete vehicle is light in total weight, energy-saving and environment-friendly;

3. the working vehicle can make way for the track line transversely, which provides convenience for the vehicle to operate in a long and large area, accompanied with higher working efficiency and wider application range;

4. vehicle lifting and steel rail lifting are reasonably combined to lighten the labor intensity and improve the construction efficiency;

5. the working vehicle has a large working space in a working state, can be attached with various working equipment and is applicable for various conditions, accompanied with high university.

### BRIEF DESCRIPTION OF THE DRAWINGS

FIG. 1 is a main view of a working state of the working vehicle;

FIG. 2 is a top view of the working state of the working vehicle;

FIG. 3 is a left view of the working state of the working vehicle;

FIG. 4 is a main view of a transfer state of the working vehicle;

FIG. 5 is a top view of the transfer state of the working vehicle;

FIG. 6 is a left view of the transfer state of the working vehicle;

FIG. 7 is a top view of an initial position where the working vehicle makes way for a track line;

FIG. 8 is a schematic top view in which the working vehicle makes way for the track line;

FIG. 9 is a schematic left view in which the working vehicle makes way for the track line;

FIG. 10a is a schematic diagram a of a thrust wheel;

FIG. 10b is a schematic diagram b of the thrust wheel;

FIG. 10c is a schematic diagram c of the thrust wheel;

FIG. 11a is a schematic diagram a of a hanging system;

FIG. 11b is a schematic diagram b of the hanging system;

FIG. 12a is a schematic diagram a of a longitudinal beam;

FIG. 12b is a schematic diagram b of the longitudinal beam;

FIG. 13a is a schematic diagram a of a driving running wheel;

FIG. 13b is a schematic diagram b of the driving running wheel;

FIG. 14a is a schematic diagram a of a driven running wheel;

FIG. 14b is a schematic diagram b of the driven running wheel;

FIG. 15a is a schematic diagram a of a driving wheel braking device;

FIG. 15b is a schematic diagram b of the driving wheel braking device;

FIG. 16a is a schematic diagram a of a driven wheel braking device;

FIG. 16b is a schematic diagram b of the driven wheel braking device;

FIG. 17a is a schematic diagram a of a transverse moving and lifting mechanism;

FIG. 17b is a schematic diagram b of the transverse moving and lifting mechanism;

FIG. 17c is a schematic diagram c of the transverse moving and lifting mechanism.

In drawings, reference symbols represent the following components: 1. vehicle body; 2. fixing and lifting mechanism; 3. driving running wheel; 4. transverse moving and lifting mechanism; 5. thrust wheel; 6. hanging system; 7. working device; 8. longitudinal beam; 9. driven running wheel; 10. driving wheel braking device; 11. driven wheel braking device; 21. fixing and lifting frame; 22. fixed jacking cylinder; 31. driving wheel axle box; 32. driving wheel axle; 33. driven belt pulley; 34. V-shaped belt; 35. driving belt pulley; 36. driving motor; 41. transverse moving guide column; 42. transverse moving guide sleeve; 43. transverse moving jacking cylinder; 44. transverse moving telescopic cylinder; 51. thrust wheel body; 52. thrust wheel mounting frame; 53. thrust wheel fixing frame; 54. thrust wheel support; 55. thrust wheel fixing shaft; 56. thrust wheel rotating shaft; 57. thrust wheel axle; 61. hanging wheel; 62. hanging frame; 63. hanging ring; 81. longitudinal beam guide sleeve; 82. longitudinal beam guide column; 83. longitudinal beam telescopic cylinder; 84. cylinder support; 86. cylinder pin shaft; 91. driven wheel box; 92. driven wheel axle; 93. center plate; 101. driving wheel braking and fixing frame; 102. driving wheel braking piston; 103. driving wheel braking shoe; 104. driving wheel braking disc; 111. driven wheel baking and fixing frame; 112. driven wheel braking piston; 113. driven wheel braking shoe; 114. driven wheel braking disc.

### DETAILED DESCRIPTIONS OF THE PREFERRED EMBODIMENTS

The present invention will now be further described with reference to the accompanying drawings, and the principles of the structure and method of the device are apparent to those skilled in the art. It should be understood that the specific embodiments described herein are merely illustrative of the present invention and are not intended to limit the present invention.

A working vehicle of the present invention is designed as a longitudinally telescopic structure. In a non-working state, a transverse moving mechanism and a lifting mechanism both contract to a “zero” state, that is, the working vehicle contracts to a smallest state. A telescopic mechanism contracts, such that the proximal end of a front vehicle body and the proximal end of a rear vehicle body are combined to facilitate long-distance driving or long-distance loading and transfer of a vehicle. When the working vehicle works on a line, thrust wheel fixing shafts are pulled out, thrust wheels are put down and supported on a steel rail, and thrust wheel fixing shafts are mounted in corresponding fixing holes in the thrust wheel mounting frame and the thrust wheel fixing frame and are positioned. The telescopic mechanism drives the vehicle bodies to extend to a working length along the steel rail direction, and is fixedly locked, and a hanging system is lowered to drive the working devices to move to a working position for working. When the working vehicle needs to be away from the main line and makes way for the track line, the working vehicle runs to a lateral line position where a space for parking the working vehicle is provided. The telescopic mechanism of the working vehicle drives the working vehicle to contract to a shortest state for transfer. The transverse moving and lifting mechanism of the working vehicle is repeatedly operated. The walking-type movement is realized by means of the fixing and lifting mechanisms at the front end and the rear end of the working vehicle till the working vehicle is completely away from the track line.

The telescopic multifunctional working vehicle capable of operating in both directions and evacuating transversely comprises a fixing and lifting mechanism and a transverse moving and lifting mechanism. The fixing and lifting mechanism is used for supporting and lifting the working vehicle. The transverse moving and lifting mechanism is used for transversely moving and lifting the working vehicle. The fixing and lifting mechanism and the transverse moving and lifting mechanism cooperate to realize transverse movement of the working vehicle. A vehicle body of the working vehicle is composed of a front vehicle body and a rear vehicle body, wherein the front vehicle body is connected with the rear vehicle body through a telescopic mechanism used for realizing the contraction and the expansion between the front vehicle body and the rear vehicle body. The telescopic mechanism further comprises a locking mechanism capable of keeping a telescopic state unchanged. The working vehicle is further provided with a hanging system used for hanging and moving working devices. The working devices include a normalizing device, a strengthening device and a polishing device. A rail clamping device is arranged at the bottom of the working vehicle and used for clamping a steel rail to lift it to a designated height together with the complete vehicle, and the working vehicle works after the steel rail is supported. Furthermore, a transformer, an intermediate-frequency power supply, a water cooling device, a power generator set and a driving motor are further disposed in the working vehicle.

The telescopic mechanism comprises at least one longitudinal beam. Each longitudinal beam is composed of longitudinal beam guide sleeves at two ends and a longitudinal beam guide column between the longitudinal beam guide sleeves. The longitudinal beam guide sleeves at two ends are fixedly connected with the front vehicle body and the rear vehicle body respectively. The two longitudinal beam telescopic cylinders are symmetrically disposed between the longitudinal beam guide column and the longitudinal beam guide sleeves at two ends. A cylinder support is arranged in the middle of the longitudinal beam guide column. A cylinder support is arranged on the lower side of each of the longitudinal beam guide sleeves at two ends respectively. Two ends of each longitudinal telescopic cylinder and the cylinder support are fixed by cylinder pin shafts. The other end of each longitudinal beam telescopic cylinder is fixedly connected with the cylinder pin shaft. The longitudinal beam guide sleeves can be driven by the two longitudinal beam telescopic cylinders to move along the longitudinal beam guide column to realize the contraction and the expansion between the front vehicle body and the rear vehicle body. The hanging system is mounted below the longitudinal beam.

The longitudinal beam is of an I-shaped structure. Tracks are symmetrically disposed on the left bottom edge and the right bottom edge in left and right grooves of the I-shaped structure. Two hanging wheels are disposed on the two tracks respectively. A left hanging frame and a right hanging frame are disposed outside the two hanging wheels respectively. A hanging ring is disposed between the hanging frames and used for fixedly connecting the working devices. The hanging wheels, the hanging frames and the hanging ring form the hanging system. The hanging wheels can be driven by a power device to move along the tracks, thereby changing the hanging position of the working devices.

The transverse moving and lifting mechanism is composed of transverse moving mechanisms and lifting mechanisms. The transverse moving mechanisms which are disposed towards two sides of the working vehicle are disposed at the bottom of the front vehicle body and the bottom of the rear vehicle body respectively. Each transverse moving mechanism comprises a transverse moving guide sleeve and a transverse moving guide column disposed in the transverse moving guide sleeve. The transverse moving guide sleeve is fixed at the lower end of the working vehicle. The transverse moving guide column is capable of moving along the transverse moving guide sleeve to realize the extension and contraction of the transverse moving mechanism. The lifting mechanism is arranged at the outer end of the transverse moving guide column. The lifting mechanism is a vertically-arranged transverse moving jacking cylinder. The upper end of the transverse moving jacking cylinder is connected with the outer end of the transverse moving guide column through the fixing and lifting frame. The lower end of the transverse moving jacking cylinder can be supported on the ground and further provided with a supporting plate or other component to ensure contact and stable support with the ground.

A thrust wheel structure is further disposed below the proximal end of the front vehicle body and the proximal end of the rear vehicle body respectively and used for supporting the middle part of the working vehicle after the front vehicle body and the rear vehicle body are expanded, thereby increasing the stability of the working vehicle. The thrust wheel structure comprises a thrust wheel support fixedly connected with the front vehicle body or the rear vehicle body. The thrust wheel support is connected with one end of a thrust wheel mounting frame through a thrust wheel rotating shaft. The other end of the support wheel mounting frame is connected with a thrust wheel body through a thrust wheel axle. The thrust wheel mounting frame is capable of rotating with one end thereof connected to the thrust wheel support as a fixed point, thereby changing the position of the thrust wheel body. A thrust wheel fixing frame is disposed inside the thrust wheel mounting frame. The thrust wheel fixing frame is provided with a plurality of fixing holes along a rotating trajectory of the thrust wheel mounting frame. The position of the thrust wheel body can be fixed by combining the fixing holes with a thrust wheel fixing shaft. When the working vehicle is not in work, each thrust wheel can be contracted to a position close to the vehicle body.

A left driving running wheel and a right driving running wheel are disposed below the rear vehicle body of the working vehicle and are connected by a driving wheel axle. Two ends of the driving wheel axle extend out of the outsides of the two driving running wheels respectively and are connected with a driving wheel axle box. A driven belt pulley is further connected to the driving wheel axle and is connected with a driving belt pulley through a V-shaped belt. The driving belt pulley is mounted on an output shaft of the driving motor. The driving wheel axle is further provided with a driving wheel braking device.

The driving wheel braking device comprises a fixing wheel fixing frame which is fixedly connected with the vehicle body. A driving wheel braking disc is mounted on the driving wheel fixing frame. The driving wheel axle passes through the center of a driving wheel braking disc. A driving wheel braking shoe and a driving wheel braking piston for controlling the driving wheel braking shoe to open are further disposed on the driving wheel braking disc.

A group of left driven running wheels and a group of right driven running wheels are disposed below the front vehicle body of the working vehicle and are connected by a driven wheel axle. Two ends of the driven wheel axle extend out of the outsides of the two groups of driven running wheels respectively and are connected with a driven wheel axle box. A driven wheel braking device is further disposed on the driven wheel axle. The front vehicle body and the driven wheel axle are connected through a center plate. Preferably, each group of the driven running wheels is composed of a front driven running wheel body and a rear driven running wheel body which are arranged in parallel.

The driven wheel braking device comprises a driven wheel fixing frame which is connected with the vehicle body. A driven wheel braking disc is mounted on the driven wheel fixing frame. The driven wheel axle passes through the center of the driven wheel braking disc. A driven wheel braking shoe and a driven wheel braking piston for controlling the driven wheel braking shoe to open are further disposed on the driven wheel braking disc.

### Embodiment 1

The working vehicle is telescopically split in the middle. When the working vehicle runs from a base to a working surface, the length of the whole vehicle is shortest. The proximal end of the front vehicle body and the proximal end of the rear vehicle body contract and are close together, and the state in this case is referred to as a “zero” state. After the vehicle drives to a position over the working surface, the thrust wheels at a vehicle body separation section are rotatably put down, and the vehicle body extends from the middle to the both sides, and the telescopic mechanism is locked after reaching a working space length. The working vehicle is braked to relieve a temporary constraint to the steel rail. The steel rai is clamped by the rail clamping device at the bottom of the working vehicle. The working vehicle is lifted to a designated height together with the steel rail by the lifting mechanism mounted on a chassis of the working vehicle and is locked. The working devices, such as a normalizing device, a polishing device, a straightening device and a flaw detection device, which are suspended on a telescopic beam of the working vehicle are moved to a working position and work. The working devices return to their positions after working. The lifting mechanism contracts to lower the steel rail and the working vehicle to an original position and contract to be away from the track bed surface. The braking of the steel rail clamping device and the working vehicle is relieved. The working vehicle moves automatically to a next working position. The transverse moving mechanism and the lifting mechanism are both driven by hydraulic cylinders.

When the working vehicle needs to be away from the main line and makes way for the tracks, the telescopic mechanism of the working vehicle drives the working vehicle to contract to a shortest state for transfer. A make-way site is selected. One side of the transverse moving mechanism of the complete vehicle is driven to extend towards a make-way direction, and the other side thereof contracts to be close to the working vehicle. Then, the transverse moving and lifting mechanism vertically lifts the working vehicle. When the running wheels of the working vehicle are away from the steel rail by a certain height, the transverse moving mechanism drives the working vehicle to move to the make-way side relative to the transverse moving guide sleeves of the transverse moving and lifting mechanism. After the working vehicle arrives at a designated position of the transverse moving guide sleeve, four fixing and lifting mechanisms mounted at the front end and the rear end of the working vehicle are jacked, such that the working vehicle is stably supported on a first transverse moving position. The transverse moving and lifting mechanism then contracts and returns to a state before the transverse movement of the first time. The transverse moving and lifting mechanism jacks and lifts the working vehicle, and the four fixing and lifting mechanisms at the front end and the rear end of the working vehicle contract to a non-supported state. The transverse movement step is repeated, such that the working vehicle safely makes way for the track line and allows other vehicles to pass through smoothly. When the working vehicle needs to return to an original working state, a step reverse to the make-way procedure is operated such that the working vehicle returns its position and continues to perform a track line operation.

### Embodiment 2

The present invention relates to an application method for the working vehicle to change from a transfer state to a working state.

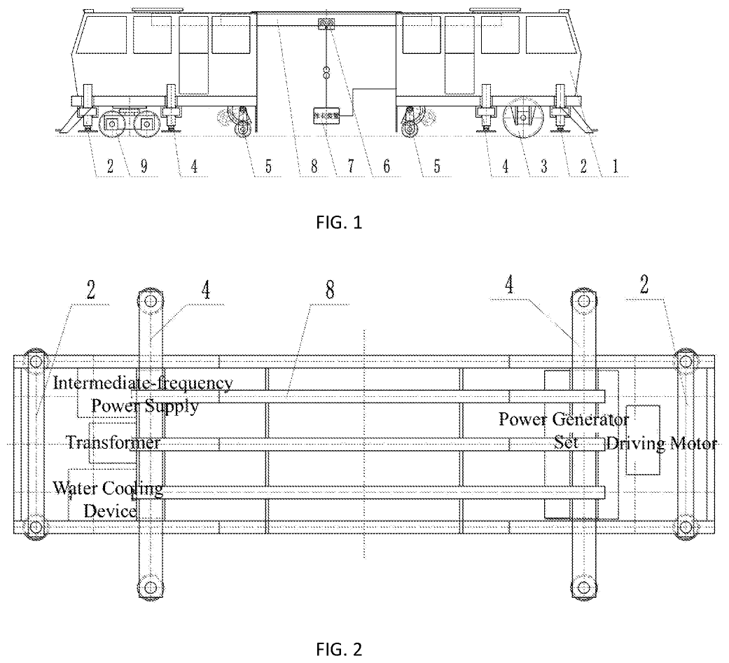

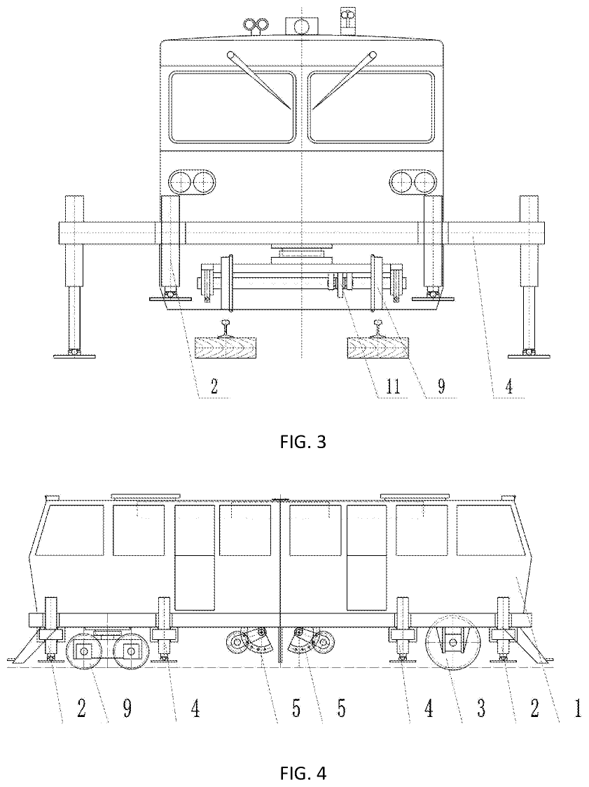

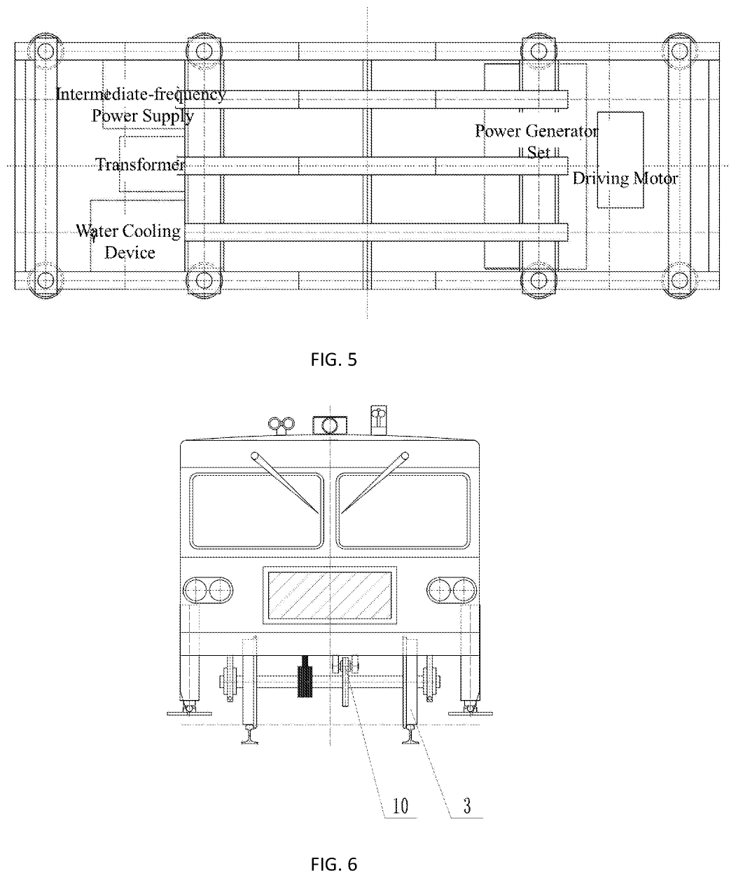

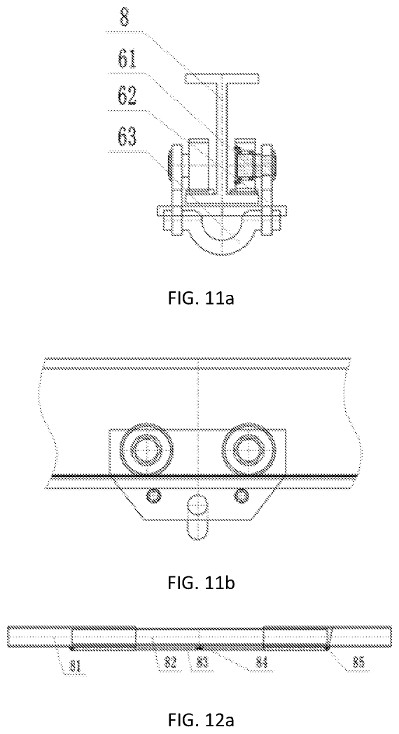

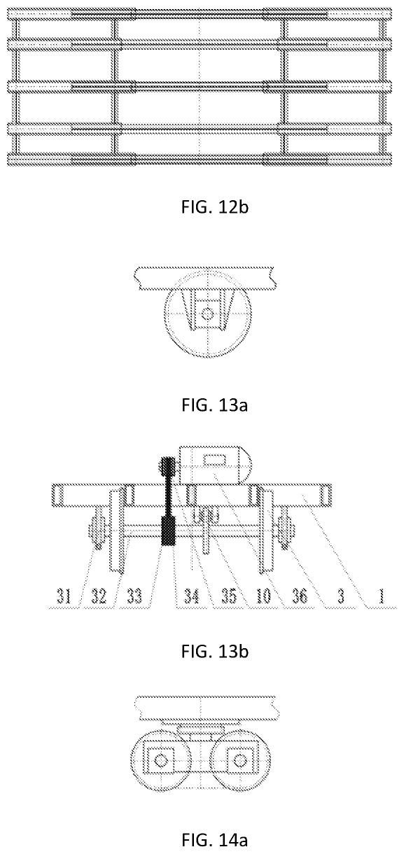

The working state of the working vehicle is as shown in FIGS. 1, 2, and 3. The transfer state of the working vehicle is as shown in FIGS. 4, 5 and 6. The main structure of this embodiment is designed as follows: five longitudinal beams are designed on the top of the structure of the vehicle body, and each longitudinal beam is a structural beam connecting the front vehicle body and the rear vehicle body and is designed as a guide sleeve and guide column structure, wherein the guide column and the guide sleeve of each of the first and fifth longitudinal beams are provided with two fixing points on which the hydraulic cylinders are mounted; the hydraulic cylinders are driven to drive the guide columns to move in the guide sleeves to realize expansion and contraction of the vehicle body; the longitudinal beams are as shown in FIGS. 12a-b. A hanging system is mounted on the second and fourth longitudinal beams and has a function of hanging and moving the working devices. The hanging system is as shown in FIGS. 11a-b.

Two sets of thrust wheels are designed near a lower frame separation position of the vehicle body and are mounted on the front vehicle body and the rear vehicle body respectively to prevent a main beam from bending and deforming caused by the weight of the hung working devices when the vehicle body is in an extended state. The thrust wheels are located in a supporting position during working, and are in a lift-up state during long-distance transfer or make-way for a line. Each thrust wheel is designed as a rotary lifting structure. The thrust wheels are as shown in FIGS. 10a-c.

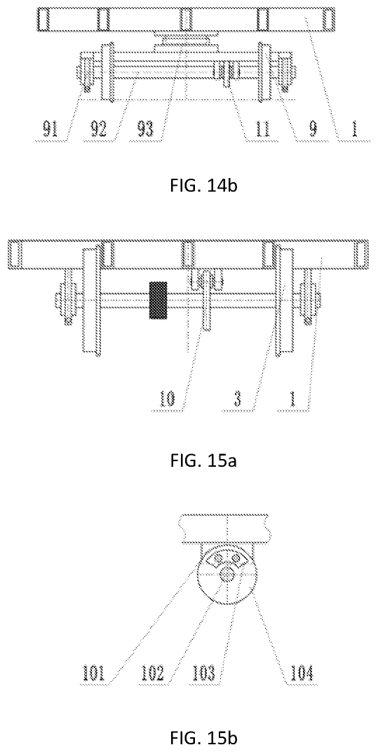

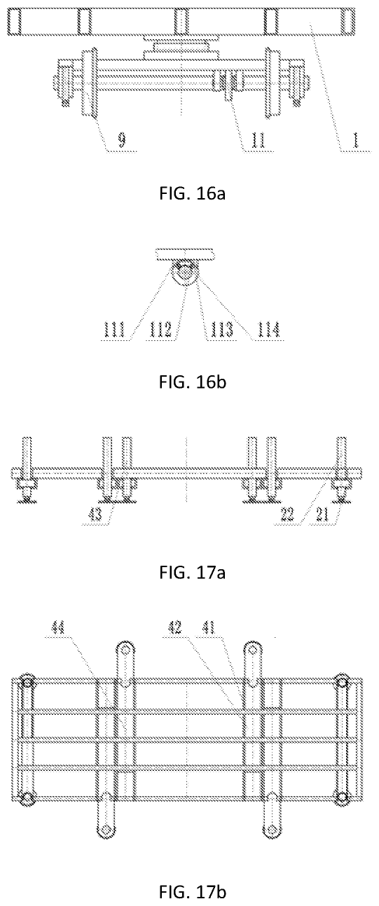

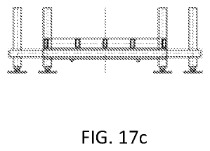

The driving running wheels are designed on the front vehicle body, the driven running wheels are designed on the rear vehicle body, and a driving wheel braking device is designed on each driving running wheel. A driven wheel baking device is designed on each driven running wheel. The transverse moving and lifting mechanisms and the fixing and lifting mechanisms of the complete vehicle are designed near the driving running wheels and the driven running wheels of the front vehicle body and the rear vehicle body. Each transverse moving and lifting mechanism is of a hydraulic cylinder transverse moving and supporting combined structure. The transverse moving mechanism of each transverse moving and lifting mechanism is designed as a guide sleeve and guide column structure. A transverse moving jacking cylinder is mounted at one end of the guide column, and the other end of the guide column is mounted in the guide sleeve. Sliding of the guide sleeves and the guide columns is realized by means of a transverse moving telescopic cylinder whose two ends are mounted on the guide sleeves and the guide columns. The transverse moving and lifting mechanism and the fixing and lifting mechanism can be operated respectively to realize a lifting function of supporting the working vehicle alternately. The steel rail clamping device is designed and mounted below the guide sleeve of the transverse moving and lifting mechanism. After the clamping device clamps the steel rail, the steel rail can ascend and descend with the vehicle body. After the steel rail is lifted and supported, the working devices work. The driving running wheels are as shown in FIGS. 13a-b, and the driven running wheels are as shown in FIGS. 14a-b. The driving wheel braking device is as shown in FIGS. 15a-b. The driven wheel braking device is as shown in FIGS. 16a-b. The transverse moving and lifting mechanism is as shown in FIGS. 17a-c.

### Embodiment 3

The present invention relates to an application method for the working vehicle to make way for a track line.

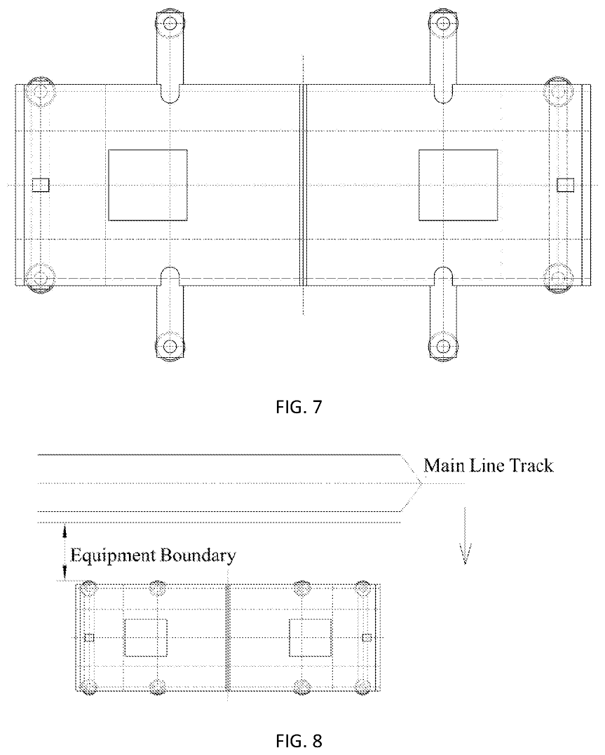

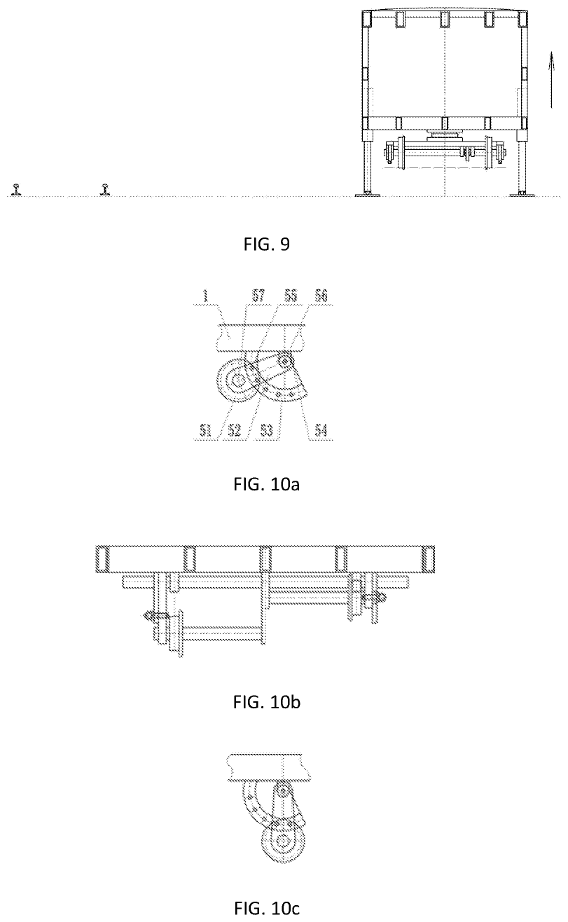

The make-way of the working vehicle for the track line is as shown in FIGS. 7, 8 and 9. Five longitudinal beams are designed on the top of the structure of the vehicle body, and each longitudinal beam is a structural beam connecting the front vehicle body and the rear vehicle body and is designed as a guide sleeve and guide column structure, wherein the guide column and the guide sleeve of each of the first and fifth longitudinal beams are provided with two fixing points on which the hydraulic cylinders are mounted. The hydraulic cylinders are driven to drive the guide columns to move in the guide sleeves to realize expansion and contraction of the vehicle body. The transverse moving and lifting mechanism and the fixing and lifting mechanism of the complete vehicle are designed near the driving running wheels and the driven running wheels. The transverse moving and lifting mechanism is of a hydraulic cylinder transverse moving and supporting combined structure. The transverse moving mechanism of the transverse moving and lifting mechanism is designed as a guide sleeve and guide column structure. A transverse moving jacking cylinder is mounted at one end of the guide column, and the other end of the guide column is mounted in the guide sleeve. Sliding of the guide sleeves and the guide columns is realized by means of a transverse moving telescopic cylinder whose two ends are mounted on the guide sleeves and the guide columns.

When the working vehicle makes way for the track line, the working vehicle contracts to a state of long-distance transfer. The working vehicle runs to a position of the track line where the outside of the line can satisfy a working vehicle storage space, and then the working vehicle is braked. The transverse moving telescopic cylinder of the transverse moving and lifting mechanism is jacked, such that the transverse moving jacking cylinders of the two vertical supports on the make-way side extend to a designed position. The four transverse moving and lifting mechanisms are jacked to vertically support the transverse moving jacking cylinders to lift the working vehicle, such that the running wheels of the working vehicle are away from the steel rail surface by a certain height. The transverse moving telescopic cylinders of the transverse moving and lifting mechanisms are jacked. The working vehicle is driven to move to the make-way side by means of the reaction force of the vertical supports of the transverse moving and lifting mechanisms to the ground friction force. After the working vehicle arrives at the designed transverse moving position of the working vehicle, the vertical support jacking cylinders of the fixing and lifting mechanisms mounted at the front end of the rear end of the working vehicle are jacked to push the cylinders so as to lift the working vehicle. The vertical support jacking cylinders of the transverse moving and lifting mechanisms contract, the vertical supports are then folded, and the transverse moving telescopic cylinders of the transverse moving and lifting mechanisms contract to drive the vertical support on the make-way side to extend towards the make-way side. Meanwhile, the vertical support on the non-make-way side is driven to contract towards the vehicle body, and, after reaching a position, jack the vertical support jacking cylinder of the transverse moving and lifting mechanism to lift the working vehicle, such that the vertical supports of the fixing and lifting mechanisms mounted at the front end and the rear end of the working vehicle are in a non-stressed state. Then, the transverse moving telescopic cylinder of the transverse moving and lifting mechanism is jacked again, and the working vehicle is driven to move to the make-way side and to arrive at a designed transverse moving position of the working vehicle by means of the reaction force of the vertical supports of the transverse moving and lifting mechanisms to the ground friction force. The above operation steps are repeated to complete the make-way of the working vehicle for the track line.

After the make-way for the track line is completed, when the working vehicle needs to restore to the main line and continue to work, the working vehicle can return to the track line for working according to the steps reverse to the make-way for the track line.

What is claimed is:

1. A telescopic multifunctional working vehicle capable of operating in both directions and evacuating transversely, comprising a fixing and lifting mechanism and a transverse moving and lifting mechanism, wherein the fixing and lifting mechanism is used for supporting and lifting the working vehicle; the transverse moving and lifting mechanism is used for transversely moving and lifting the working vehicle; the working vehicle is composed of a front vehicle body and a rear vehicle body, wherein the front vehicle body is connected with the rear vehicle body through a telescopic mechanism used for realizing the contraction and the expansion between the front vehicle body and the rear vehicle body; the working vehicle is further provided with a hanging system used for hanging and moving working devices; a rail clamping device is arranged at the bottom of the working vehicle.

2. The telescopic multifunctional working vehicle capable of operating in both directions and evacuating transversely according to claim 1, wherein the telescopic mechanism comprises at least one longitudinal beam; each longitudinal beam is composed of longitudinal beam guide sleeves at two ends and a longitudinal beam guide columns between the longitudinal beam guide sleeves; the longitudinal beam guide sleeves at two ends are fixedly connected with the front vehicle body and the rear vehicle body respectively; the longitudinal beam guide sleeves are capable of moving along the longitudinal beam guide column to realize the contraction and the expansion between the front vehicle body and the rear vehicle body.

3. The telescopic multifunctional working vehicle capable of operating in both directions and evacuating transversely according to claim 1, wherein the transverse moving and lifting mechanism is composed of a transverse moving mechanism and a lifting mechanism; the transverse moving mechanism comprises a transverse moving guide sleeve and a transverse moving guide column disposed in the transverse moving guide sleeve; the transverse moving guide sleeve is fixed at the lower end of the working vehicle; the transverse moving guide column is capable of moving along the transverse moving guide sleeve to realize the extension and contraction of the transverse moving mechanism; the lifting mechanism is arranged at the outer end of the transverse moving guide column.

4. The telescopic multifunctional working vehicle capable of operating in both directions and evacuating transversely according to claim 1, wherein a hanging system is arranged on the longitudinal beam.

5. The telescopic multifunctional working vehicle capable of operating in both directions and evacuating transversely according to claim 1, wherein the working devices include a normalizing device, a straightening device and a polishing device.

6. The telescopic multifunctional working vehicle capable of operating in both directions and evacuating transversely according to claim 1, wherein a thrust wheel is arranged below a proximal end of the front vehicle body and a proximal end of the rear vehicle body respectively; each thrust wheel is capable of contracting to a position close to the corresponding vehicle body.

7. An application method for the telescopic multifunctional working vehicle capable of operating in both directions and evacuating transversely according to claim 1, comprising a working method which is specifically as follows:
a1. operating the working vehicle to run to a working site; relieving a longitudinal separation constraint between the front vehicle body and the rear vehicle body; putting the thrust wheel in the middle of each vehicle body down; operating a telescopic mechanism to enable the front vehicle body and the rear vehicle body of the working vehicle to expand and to extend to a designated working position respectively, and then locking vehicle braking and the telescopic mechanism;
a2. operating the rail clamping device mounted below the working vehicle to clamp a steel rail;
a3. operating the transverse moving and lifting mechanism of the working vehicle to lift the working vehicle and the steel rail, such that the steel rail leaves from a track bed surface by a set height, and then supporting a space below the lifted steel rail;
a4. operating the hanging system of the working vehicle to lower the working devices to the lower steel rail for working; then lifting the working devices; and
a5. removing the support from the lower part of the steel rail, and operating the transverse moving and lifting mechanism of the working vehicle to lower the working vehicle and the steel rail, such that the steel rail falls into a rail bearing slot of the track bed and the working vehicle fails onto the steel rail; and relieving the clamping of the rail clamping device from the steel rail.

8. The application method for the telescopic multifunctional working vehicle capable of operating in both directions and evacuating transversely according to claim 7, wherein the working method further comprises:
a6. relieving the vehicle braking, and operating the telescopic mechanism to contract the front vehicle body and the rear vehicle body of the working vehicle; operating the working vehicle to run to the next working surface or directly operating the working vehicle to run to the next working surface; and repeating the steps a1-a5.

9. The application method for the telescopic multifunctional working vehicle capable of operating in both directions and evacuating transversely according to claim 7, further comprising a transverse moving make-way method, wherein the transverse moving make-way method is specifically as follows:
b1. longitudinally contracting the front vehicle body and the rear vehicle body of the working vehicle to a shortest state, and locking the telescopic mechanism;
b2. supporting the working vehicle by the fixing and lifting mechanism, and operating the transverse moving and lifting mechanism of the working vehicle to extend towards the make-way side of the vehicle, and meanwhile making the non-make-way side to approach to the working vehicle.
b3. operating the transverse moving and lifting mechanism of the working vehicle to lift the entire working vehicle, such that running wheels of the working vehicle are away from the steel rail surface; then operating the transverse moving and lifting mechanism to move the working vehicle towards the make-way side; and
b4. operating the fixing and lifting mechanism to support the working vehicle after transverse moving is completed, and then operating the transverse moving and lifting mechanism to return to a set height position that is off the ground.

10. The application method for the telescopic multifunctional working vehicle capable of operating in both directions and evacuating transversely according to claim 9, wherein the transverse moving make-way method further comprises:
b5. repeating the steps b2-b4 to complete long-distance transverse moving make-way of the working vehicle.
